(19) United States
(12) Patent Application Publication
(10) Pub. No.: US 2015/0197048 A1
(43) Pub. Date: Jul. 16, 2015

(54) METAL-AND-RESIN COMPOSITE AND METHOD FOR MAKING THE SAME

(71) Applicants: SHENZHEN FUTAIHONG PRECISION INDUSTRY CO., LTD., Shenzhen (CN); FIH (HONG KONG) LIMITED, Kowloon (HK)

(72) Inventors: CHWAN-HWA CHIANG, New Taipei (TW); CHIEH-HSIANG WANG, New Taipei (TW); BAO-SHEN ZHANG, Shenzhen (CN)

(21) Appl. No.: 14/522,310

(22) Filed: Oct. 23, 2014

(30) Foreign Application Priority Data
Jan. 16, 2014 (CN) 201410019580.9

(51) Int. Cl. B29C 45/14; B32B 15/04; C25D 11/34; C25D 11/16; C25D 11/26; C25D 11/30; B32B 5/18; B32B 27/06

(52) U.S. Cl. CPC B29C 45/14311; B32B 5/18; B32B 15/04; B32B 27/06; C25D 11/16; C25D 11/26; C25D 11/30; C25D 11/34; B32B 2250/04; B32B 2266/04; B29K 2101/12

(57) ABSTRACT

A metal-and-resin composite includes a metal substrate, an anodic oxide layer defining nano pores formed on the substrate, an intermediate layer including coupling agent formed on the surface of the anodic oxide layer, and a resin article covering and coupled to the intermediate layer.

### FIELD

The present disclosure generally relates to a metal-and-resin composite and a method for making the metal-and-resin composite.

### BACKGROUND

Many people use portable electronic devices such as mobile phones and personal digital assistants (PDAs). Housings of the portable electronic devices may be made of two or more different materials, such as metal and resin. There is a need to combine metal and resin together.

### BRIEF DESCRIPTION OF THE DRAWINGS

Implementations of the present technology will now be described, by way of example only, with reference to the attached figures.

FIG. 1 is a cross-sectional view of an exemplary embodiment of a metal-and-resin composite.

FIG. 2 is a cross-sectional view of a mold for making the composite shown in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

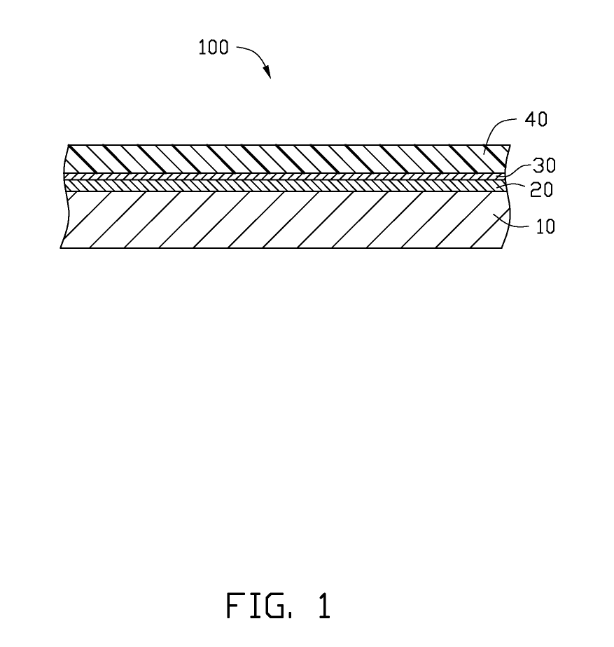

A method for making a composite 100 as shown in FIG. 1 may include the following steps:

A metal substrate 10 is provided. The metal substrate 10 is made of aluminum, aluminum alloy, titanium, aluminum-magnesium alloy, magnesium alloy, zinc, zinc alloy, or aluminum-zinc alloy.

The metal substrate 10 is degreased. This step may use a neutral cleaning agent for cleaning metal. The step may be carried out by dipping the metal substrate 10 in the neutral cleaning agent having a concentration of about 5 g/L to about 20 g/L and a temperature of about 40° C. to about 75° C., allowing the metal substrate 10 to be ultrasonically cleaned for about 3 minutes to about 10 minutes.

The degreased metal substrate 10 is then etched using an alkali solution to remove an metal oxide film which may naturally form on the surface of the metal substrate 10. This step may be carried out by dipping the metal substrate 10 in the alkali solution for about 2 minutes to about 5 minutes. The alkali solution comprises at least one alkali chosen from a group consisting of sodium hydroxide, potassium hydroxide, and ammonium bifluoride. The alkali solution has a concentration of about 5 g/L to about 40 g/L.

The etched metal substrate 10 is then cleaned to remove etch-resulting impurities. This step may be carried out by dipping the metal substrate in a nitric acid solution for about 5 seconds to about 180 seconds. The nitric acid solution has a concentration of about 30 g/L to about 150 g/L.

The cleaned metal substrate 10 is anodized to form an anodic oxide layer 20 on the metal substrate 10. This step may be carried out in a sulphuric acid solution having a concentration of about 150 g/L to about 250 g/L. During the anodizing process, the sulphuric acid solution is kept at a temperature of about 10° C. to 50° C., and a voltage of about 8 V to about 25 V is applied to the metal substrate 10. The anodizing process may last for about 10 min to about 40 min. The anodic oxide layer 20 defines a plurality of nano pores having a diameter of about 5 nm to about 25 nm and a depth of about 1 μm to about 9 μm. The anodic oxide layer 20 has a thickness of about 1 μm to about 9 μm, and oxygen atoms distributed on the surface of the anodic oxide layer have a weight percentage of about 35% to about 50%.

An intermediate layer 30 is formed on the surface of the anodic oxide layer 20. This step may be carried out by dipping the anodized metal substrate 10 in a coupling agent solution having a weight concentration of about 0.1% to about 10% and a temperature of about 25° C. to about 100° C. for about 1 second to about 5 minutes, and then drying the coupling agent solution to form the intermediate layer 30 on the surface of the anodic oxide layer 20. The coupling agent solution contains a solvent; and the solvent may be water or ethanol. During this step, the coupling agent solution may flow into the nano pores of the anodic oxide layer 20, and on drying may form a coupling agent film on the wall of the nano pores. The coupling agent is titanate coupling agent, aluminate coupling agent, zirconate coupling agent, aluminium-titanium compound coupling agent, boric acid ester coupling agent, or sulfonic acid coupling agent. The intermediate layer 30 has a thickness of about 0.5 nm to about 10 nm.

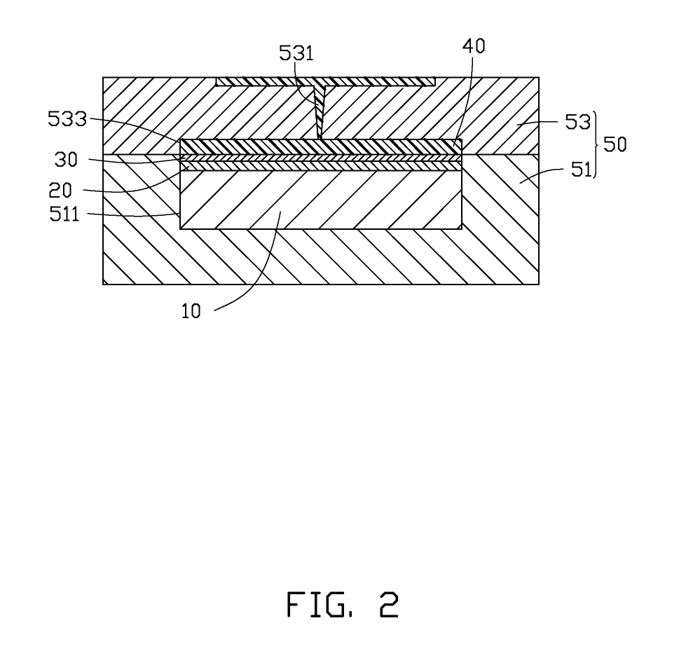

Referring to FIG. 2, an injection mold 50 is provided. The injection mold 50 includes a core insert 53 and a cavity insert 51. The core insert 53 defines a gate 531, and a first cavity 533. The cavity insert 51 defines a second cavity 511 for receiving the metal substrate 10. The metal substrate 10 having the anodic oxide layer 20 and the intermediate layer 30 is located in the second cavity 511, and molten resin is injected through the gate 531 to cover the surface of the intermediate layer 30 and fill the nano pores, and finally fill the first cavity 533 to form a resin article 40. The composite 100 is thus formed. During the injection molding step, the molten resin keeps a temperature of about 220° C. to about 320° C. The resin article 40 is made of polybutylene terephthalate (PBT), polyphenylene sulfide (PPS), polyethylene terephthalate (PET), polyetheretherketone (PEEK), polycarbonate (PC), or polyvinyl chloride (PVC). The bond between the resin article 40 and the intermediate layer 30 includes chemical bondings.

FIG. 1 illustrates the composite 100 made by the above-described method. The composite 100 includes the metal substrate 10, the anodic oxide layer 20 defining nano pores formed on the metal substrate 10, the intermediate layer 30 formed on the surface of the anodic oxide layer 20, and the resin article 40 coupled to the surface of the intermediate layer 30.

The metal substrate 10 is made of aluminum, aluminum alloy, titanium, aluminum-magnesium alloy, magnesium alloy, zinc, zinc alloy, or aluminum-zinc alloy. The anodic oxide layer 20 has a thickness of about 1 μm to about 9 μm and defines a plurality of nano pores having a diameter of about 5 nm to about 25 nm and a depth of about 1 μm to about 9 μm. The intermediate layer 30 comprises coupling agent. The coupling agent is titanate coupling agent, aluminate coupling agent, zirconate coupling agent, aluminium-titanium compound coupling agent, boric acid ester coupling agent, or sulfonic acid coupling agent. The intermediate layer 30 has a thickness of about 1 nm to about 100 nm. The resin article 40 is made of PBT, PPS, PET, PEEK, PC, or PVC. The bond between the resin article 40 and the intermediate layer 30 includes chemical bondings. The shear strength of the composite 100 is about 10 KgF/cm² to about 40 KgF/cm².

### EXAMPLE 1

In this example, the metal substrate 10 was made of aluminum alloy 5052, and the resin article 40 was made of PBT.

The metal substrate 10 was degreased by dipping in a neutral cleaning agent for aluminum having a concentration of 25 g/L and a temperature of 60° C., allowing the metal substrate 10 to be ultrasonically cleaned, for 6 min.

The degreased metal substrate 10 was etched by dipping in a sodium hydroxide solution having a concentration of 50 g/L for 0.5 min.

The etched metal substrate 10 was cleaned by dipping in a nitric acid solution having a concentration of 150 g/L for 1 min.

The cleaned metal substrate 10 was anodized to form an anodic oxide layer 20 having a thickness of 5 μm. The anodizing was carried out in a sulphuric acid solution having a concentration of about 300 g/L. During the anodizing process, a voltage of 13 V was applied to the metal substrate, the sulphuric acid solution kept at a temperature of about 20° C. The anodizing process lasted for about 15 min.

The metal substrate 10 having the anodic oxide layer 20 was dipped in an aluminate coupling agent solution having a weight concentration of 3% and a temperature of 40° C. for about 10 seconds, and dried in an oven having an interior temperature of 60° C. for 15 min, to form an intermediate layer 30 on the anodic oxide layer 20. The intermediate layer 30 had a thickness of 1-10 nm.

Molten PBT resin having a temperature of 285° C. was injected to the surface of intermediate layer 30, and finally formed the resin article 40.

### EXAMPLE 2

In this example, the metal substrate 10 was made of aluminum-magnesium alloy and the resin article 40 was made of PPS.

The metal substrate 10 was degreased by dipping in a neutral cleaning agent for aluminum having a concentration of 25 g/L and a temperature of 60° C., allowing the metal substrate 10 to be ultrasonically cleaned, for 6 min.

The degreased metal substrate 10 was etched by dipping in a sodium hydroxide solution having a concentration of 30 g/L, for 1 min.

The etched metal substrate 10 was cleaned by dipping in a nitric acid solution having a concentration of 150 g/L, for 1 min.

The cleaned metal substrate 10 was anodized to form an anodic oxide layer 20 having a thickness of 8 μm. The anodizing was carried out in a sulphuric acid solution having a concentration of about 100 g/L. During the anodizing process, a voltage of 13 V was applied to the metal substrate, the sulphuric acid solution kept at a temperature of about 20° C. The anodizing process lasted for about 30 min.

The metal substrate 10 having the anodic oxide layer 20 was dipped in a sulfonic acid coupling agent solution having a weight concentration of 2% and a temperature of 40° C. for about 60 seconds, and dried in an oven having an interior temperature of 60° C. for 15 min, to form an intermediate layer 30 on the anodic oxide layer 20. The intermediate layer 30 had a thickness of 1-10 nm.

Molten PBT resin having a temperature of 320° C. was injected to the surface of intermediate layer 30 and finally formed the resin article 40.

### EXAMPLE 3

In this example, the metal substrate 10 was made of aluminum-magnesium alloy, and the resin article 40 was made of PA.

The metal substrate 10 was degreased by dipping in a neutral cleaning agent for aluminum having a concentration of 25 g/L and a temperature of 60° C., allowing the metal substrate 10 to be ultrasonically cleaned, for 6 min.

The degreased metal substrate 10 was etched by dipping in a sodium hydroxide solution having a concentration of 40 g/L, for 0.5 min.

The etched metal substrate 10 was cleaned by dipping in a nitric acid solution having a concentration of 150 g/L, for 1 min.

The cleaned metal substrate 10 was anodized to form an anodic oxide layer 20 having a thickness of 3 μm. The anodizing was carried out in a sulphuric acid solution having a concentration of about 200 g/L. During the anodizing process, a voltage of 13 V was applied to the metal substrate, the sulphuric acid solution kept at a temperature of about 20° C. The anodizing process lasted for about 10 min.

The metal substrate 10 having the anodic oxide layer 20 was dipped in a boric acid ester coupling agent solution having a weight concentration of 3% and a temperature of 30° C. for about 15 seconds, and dried in an oven having an interior temperature of 60° C. for 15 min, to form an intermediate layer 30 on the anodic oxide layer 20. The intermediate layer 30 had a thickness of 1-10 nm.

Molten PBT resin having a temperature of 220° C. was injected to the surface of intermediate layer 30 and finally formed the resin article 40.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiments of the disclosure.

What is claimed is:

1. A metal-and-resin composite comprising:
a metal substrate;
an anodic oxide layer formed on the metal substrate, the anodic oxide layer defining nano pores;
an intermediate layer comprising a coupling agent formed on the surface of the anodic oxide layer; and
a resin article coupled to the intermediate layer.

2. The metal-and-resin composite as claimed in claim 1, wherein the intermediate layer has a thickness of about 0.5 nm to about 10 nm.

3. The metal-and-resin composite as claimed in claim 1, wherein the coupling agent is titanate coupling agent, aluminate coupling agent, zirconate coupling agent, aluminium-titanium compound coupling agent, boric acid ester coupling agent, or sulfonic acid coupling agent.

4. The metal-and-resin composite as claimed in claim 1, wherein the nano pores have a diameter of about 5 nm to about 25 nm and a depth of about 1 μm to about 9 μm.

5. The metal-and-resin composite as claimed in claim 1, wherein the anodic oxide layer has a thickness of about 1 μm to about 9 μm, and oxygen atoms distributing on the surface of the anodic oxide layer have a weight percentage of about 35% to about 50%.

6. The metal-and-resin composite as claimed in claim 1, wherein bond between the resin article and the intermediate layer comprises chemical bondings.

7. The metal-and-resin composite as claimed in claim 1, wherein the resin article is made of polybutylene terephthalate, polyphenylene sulfide, polyethylene terephthalate, polyetheretherketone, polycarbonate, or polyvinyl chloride polymer.

8. The metal-and-resin composite as claimed in claim 1, wherein the resin of the resin article fills the nano pores.

9. The metal-and-resin composite as claimed in claim 1, wherein a coupling agent film forms on the wall of the nano pores, and the resin of the resin article fills the nano pores.

10. A method for making a metal-and-resin composite, comprising:
providing a metal substrate;
forming an anodic oxide layer on the surface of the metal substrate by anodizing the metal substrate, the anodic oxide layer defining nano pores;
forming an intermediate layer on the surface of the anodic oxide layer by dipping the anodized metal substrate in a coupling agent solution; and
inserting the metal substrate in a mold and molding resin on the surface of the intermediate layer to form a resin article.

11. The method as claimed in claim 10, wherein the metal substrate is made of aluminum, aluminum alloy, titanium, aluminum-magnesium alloy, magnesium alloy, zinc, zinc alloy, or aluminum-zinc alloy.

12. The method as claimed in claim 10, further comprising steps of degreasing, etching, and cleaning the metal substrate before anodizing the substrate.

13. The method as claimed in claim 12, wherein the etching step is carried out by dipping the metal substrate in an alkaline solution comprising at least one alkali chosen from a group consisting of sodium hydroxide, potassium hydroxide, and ammonium bifluoride, the alkaline solution has a concentration of about 5 g/L to about 40 g/L.

14. The method as claimed in claim 12, wherein the cleaning step is carried out by dipping the metal substrate in a nitric acid solution, the nitric acid solution has a concentration of about 30 g/L to about 150 g/L.

15. The method as claimed in claim 10, wherein anodizing the metal substrate is carried out in a sulphuric acid solution having a concentration of about 150 g/L to about 250 g/L and a temperature of about 10° C. to 50° C., the metal substrate is applied a voltage of about 8 V to about 25 V, and the anodizing process lasts for about 10 min to about 40 min.

16. The method as claimed in claim 10, wherein the nano pores have a diameter of about 5 nm to about 25 nm and a depth of about 1 μm to about 9 μm.

17. The method as claimed in claim 10, wherein the anodic oxide layer has a thickness of about 1 μm to about 9 μm, and oxygen atoms distributing on the surface of the anodic oxide layer have a weight percentage of about 35% to about 50%.

18. The method as claimed in claim 10, wherein the resin is polybutylene terephthalate, polyphenylene sulfide, polyethylene terephthalate, polyetheretherketone, polycarbonate, or polyvinyl chloride polymer.

19. The method as claimed in claim 10, wherein bond between the resin article and the intermediate layer comprises chemical bondings.

20. The method as claimed in claim 10, wherein forming the intermediate layer is carried out by dipping the anodized metal substrate in the coupling agent solution having a weight concentration of about 0.1% to about 10% and a temperature of about 25° C. to about 100° C. for about 1 second to about 5 minutes, and then drying the coupling agent solution to form the intermediate layer on the surface of the anodic oxide layer.
